(19) United States
(12) Patent Application Publication
(10) Pub. No.: US 2016/0251021 A1
(43) Pub. Date: Sep. 1, 2016

(54) CONNECTOR SYSTEM FOR SECURING STACKED CONTAINERS

(71) Applicant: Mi-Jack Products, Inc., Hazel Crest, IL (US)

(72) Inventors: John J. Lanigan, SR., Orland Park, IL (US); Martin C. Conneally, Downers Grove, IL (US); Antonio Carlos Callado Souza, Chicago, IL (US); Jason Schmidt, Flossmoor, IL (US); Kevin Gerald Muszynski, Lockport, IL (US)

(21) Appl. No.: 15/019,736

(22) Filed: Feb. 9, 2016

Related U.S. Application Data
(60) Provisional application No. 62/126,198, filed on Feb. 27, 2015.

(51) Int. Cl. B61D 45/00; B60P 7/13; B65D 90/00

(52) U.S. Cl. CPC B61D 45/007; B65D 90/0006; B60P 7/13

(57) ABSTRACT

A connector system for connecting stacked containers includes a frame and a locating lever coupled to the frame. The locating lever is configured to detect when a lower container is placed into a containment cavity. The system further includes a coupler plate tucked along the frame in a starting position. The coupler plate is deployed to a deployed position distal to the frame in response to the locating lever detecting when the lower container is placed into the containment cavity. The connector system further includes a plurality of connecting pins such that the coupler plate and the connecting pins are configured to connect an upper container to the lower container. A return lever is coupled to the frame, and a return mechanism returns the coupler plate to the starting position in response to the upper container being lifted off of the lower container.

### CROSS REFERENCE TO RELATED APPLICATIONS

The present application claims the benefit of Lanigan, Sr. et al., U.S. provisional patent application Ser. No. 62/126,198, filed on Feb. 27, 2015, and entitled “Intermodal Transfer Management System”. The entire contents of this application are incorporated herein by reference.

### REFERENCE REGARDING FEDERALLY SPONSORED RESEARCH OR DEVELOPMENT

Not applicable

### SEQUENTIAL LISTING

Not applicable

### FIELD OF THE DISCLOSURE

The present subject matter relates to the securing of cargo involved in intermodal transportation, and more particularly, to the securing of shipping containers on a rail car.

### BACKGROUND

Under today's standards, goods are often transported from one location to another via an intermodal transportation system that combines shipment by air, sea, rail, and land. To facilitate the shipment of goods between one form of transportation and another, goods are shipped in containers that can be loaded on container ships, truck chassis, and rail cars.

To allow for a greater volume of goods to be shipped via rail, the rail cars that are used to transport the containers are designed so as to allow at least two containers to be stacked one on top of another, thereby at least doubling the number of containers a single train can carry. Containers must be secured not only within the rail car, but to one another, in order to safely transport shipping containers stacked one on top of another. The stacking of containers is also useful for other modes of transportation and storage.

Currently containers stacked one on top of another are secured to each other through the use of a connector that has to be manually inserted and locked or unlocked each time a rail car is loaded or unloaded. The use of these conventional connectors requires an individual to climb up the side of the bottom container in each car to insert and lock at least four connectors, one on each corner of the containers. In addition to being time consuming, such an evolution is also dangerous, particularly in bad weather. Furthermore, the use of manually installed connectors presents an opportunity for problems to occur should the manual connectors not be properly locked when inserted, or be tampered with once they are, thereby allowing a top container to slide and possibly tumble off of a rail car while the train is in transit.

The shipping containers stacked one on top of another are typically of standardized size and shape. Further, the locations whereto connectors may be attached to the shipping containers are widely standardized. Therefore, it may be possible to provide a connection between containers and rail cars that makes use of these standard connection locations.

For these and other reasons, a connector system for securing stacked containers that could be used to lock stacked containers together without the need for manual intervention would be an important improvement in the art.

### SUMMARY

According to one aspect, a connector system for connecting stacked containers includes a frame and a locating lever coupled to the frame. The locating lever is configured to detect when a lower container is placed into a containment cavity. The system further includes a coupler plate tucked along the frame in a starting position. The coupler plate is deployed to a deployed position distal to the frame in response to the locating lever detecting when the lower container is placed into the containment cavity. The connector system further includes a plurality of connecting pins such that the coupler plate and the connecting pins are configured to connect an upper container to the lower container. A return lever is coupled to the frame, and a return mechanism returns the coupler plate to the starting position in response to the upper container being lifted off of the lower container.

According to another aspect, a connector system for securing containers for transport or storage includes a frame. The frame includes a plurality of levers and a plurality of springs such that the levers and springs are configured so that the levers are contacted by a lower container when the lower container is placed into a containment cavity. The system further includes a plurality of connecting pins and a coupler plate such that at least one of the plurality of connecting pins is attached to the coupler plate. Further, the coupler plate is arranged alongside the frame in a stored position until one of the plurality of levers is contacted by the lower container. The coupler plate is deployed in response to one of the plurality of levers being contacted by the lower container, and the coupler plate when deployed extends substantially horizontal from the frame to a deployed position.

According to another aspect, a method for securing containers includes lowering a first container into a containment cavity with a frame aligned therealong. The frame has attached thereto a locating lever, a return lever, a coupler plate, a locking pin, and at least one spring. The method further includes detecting the first container with the locating lever as the first container is lowered into the containment cavity, activating the return lever such that the at least one spring is compressed in response to the first container contacting the return lever, and deploying the coupler plate. The coupler plate is stowed against the frame in a first position, and it is extended substantially horizontally from the frame in a second position, in response to the locating lever detecting that the first container has been lowered into the containment cavity. The method still further includes lowering a second container on top of the first container such that the coupler plate is positioned between the first container and the second container. The coupler plate includes a plurality of connecting pins that are inserted into the first and second containers when the second container is lowered onto the first container. The locking pin is deployed, and further it is inserted into one of the first and second containers when it is deployed.

Other aspects and advantages will become apparent upon consideration of the following detailed description and the attached drawings wherein like numerals designate like structures throughout the specification.

### BRIEF DESCRIPTION OF THE DRAWINGS

FIG. 1 is an isometric view of a connector system for connecting a lower container, an upper container, and a rail car;

FIG. 1A is an isometric view of the connector system connecting the lower container, the upper container, and the rail car;

FIG. 2 is an isometric view of one side of the connector system of FIG. 1 as well as the lower container;

FIG. 3 is an exploded view of the side of the connector system of FIG. 2;

FIG. 4A is a side elevation view and half-section of a portion of the connector system of FIG. 2 as well as the lower container;

FIG. 4B is an isometric view and half-section of the portion of the connector system depicted in 4A as well as the lower container;

FIG. 5A is a side elevation view and half-section of a portion of the connector system of FIG. 2 as well as the lower container;

FIG. 5B is an isometric view and half-section of the portion of the connector system depicted in 5A as well as the lower container;

FIG. 6A is a side elevation view and half-section of a portion of the connector system of FIG. 2 as well as the lower container;

FIG. 6B is an isometric view and half-section of the portion of the connector system depicted in 6A as well as the lower container;

FIG. 7A is a side elevation view and half-section of a portion of the connector system of FIG. 2 as well as the lower container and a spreader;

FIG. 7B is an isometric view and half-section of the portion of the connector system depicted in FIG. 7A as well as the lower container and the spreader;

FIG. 8 is a side elevation view and half-section of the portion of the connector system depicted in FIG. 7A as well as the lower container and the spreader as the spreader is removed from the rail car;

FIG. 9A is a side elevation view and half-section of a portion of the connector system of FIG. 2 as well as the lower container;

FIG. 9B is an isometric view and half-section of the portion of the connector system depicted in FIG. 9A as well as the lower container;

FIG. 10A is a side elevation view and half-section of the portion of the connector system depicted in FIG. 2 as well as the lower container as the upper container is lowered towards the lower container in the rail car;

FIG. 10B is an isometric view and half-section of the portion of the connector system depicted in FIG. 10A as well as the lower container as the upper container is lowered towards the lower container in the rail car;

FIG. 11A is a side elevation view and half-section of the portion of the connector system depicted in FIG. 2 as well as the lower container as the upper container is lowered further towards the lower container in the rail car;

FIG. 11B is an isometric view and half-section of the portion of the connector system depicted in FIG. 11A as well as the lower container as the upper container is lowered further towards the lower container in the rail car;

FIG. 11C is an alternative isometric view and half-section of the portion of the connector system depicted in FIG. 11A showing interior components of the connector system from another angle as well as the lower container as the upper container is lowered further into the rail car;

FIG. 12A is a side elevation view and half-section of the portion of the connector system depicted in FIG. 2 as the upper container is placed on the lower container; and

FIG. 12B is an isometric view and half-section of the portion of the connector system depicted in FIG. 12A as the upper container is placed on the lower container.

### DETAILED DESCRIPTION

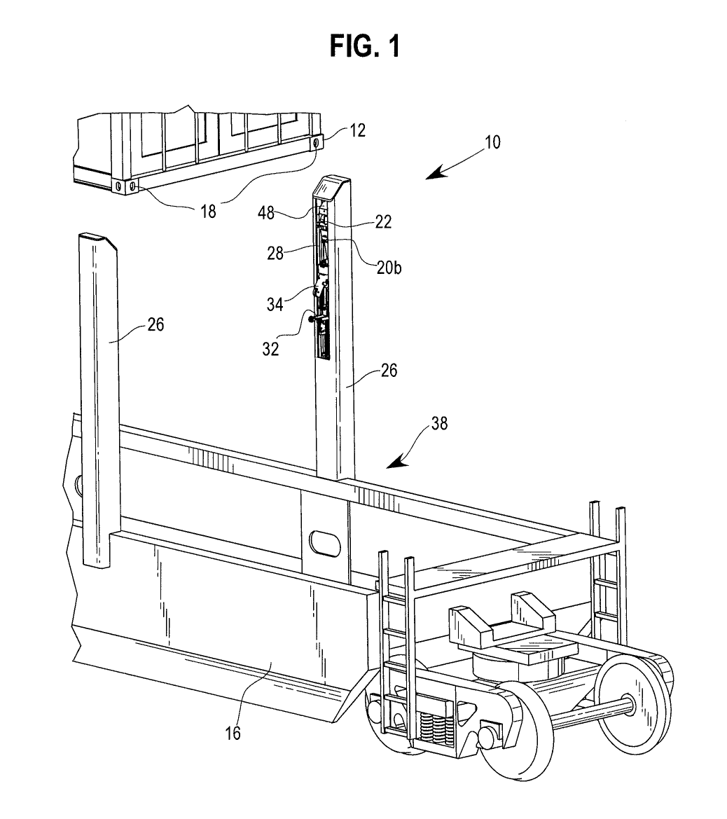

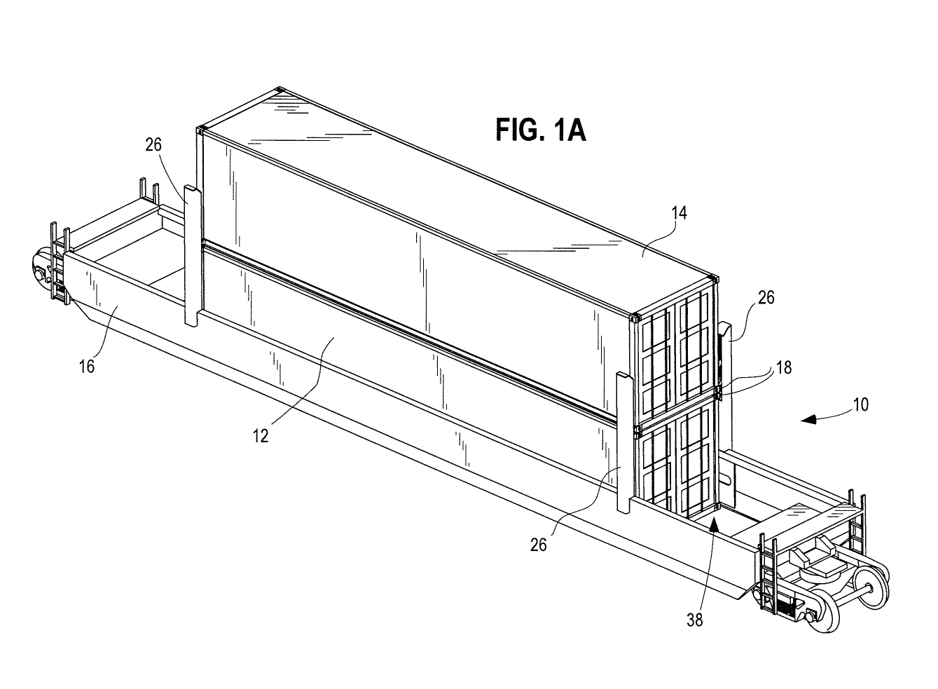

Referring to FIG. 1, disclosed is a connector system 10 for connecting lower and upper containers 12, 14 within a rail car 16. The connector system 10 accepts the lower and upper containers 12, 14 while connecting the containers at predetermined connecting points 18 where the containers meet when stacked. The connector system 10 secures the lower and upper containers 12, 14 together before the containers are transported by the rail car 16.

Referring now to FIG. 1A, the connector system 10 is depicted as connecting lower and upper containers 12, 14 within and to the rail car 16. The connector system 10 is arranged along the sides of the containers and holds the lower and upper containers 12, 14 securely together during transportation by the rail car 16. Following completion of railway transport the upper container 14 may be disconnected from the lower container 12 (described in detail below), and both the lower and upper containers 12, 14 may be removed from the rail car 16.

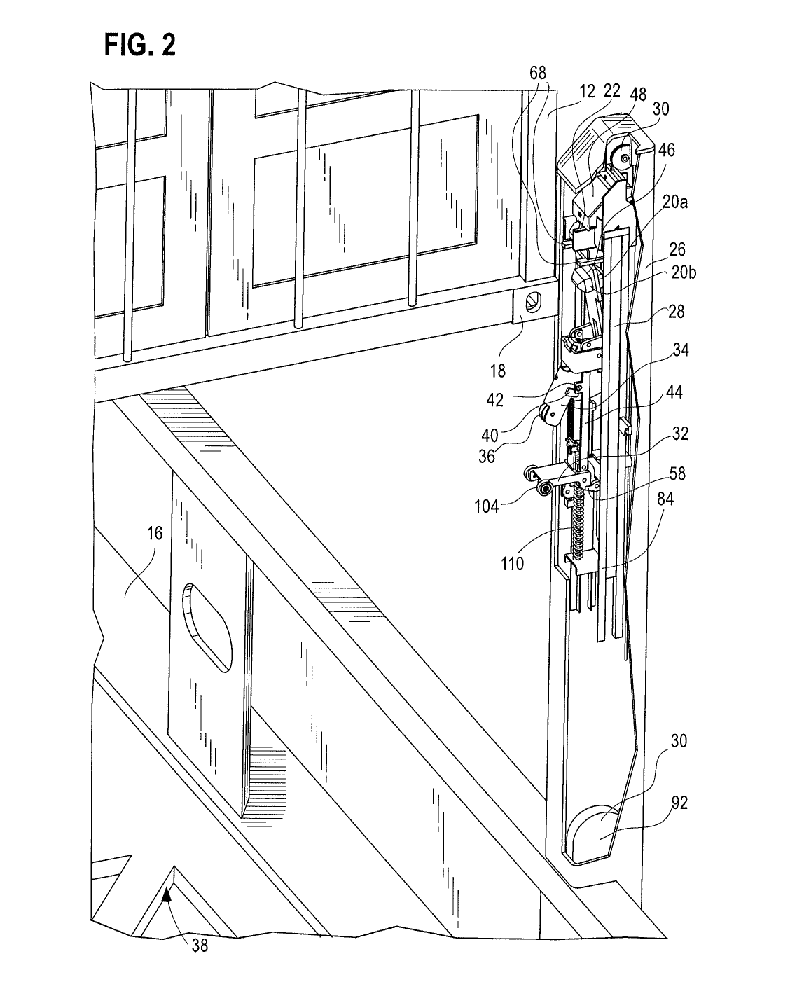

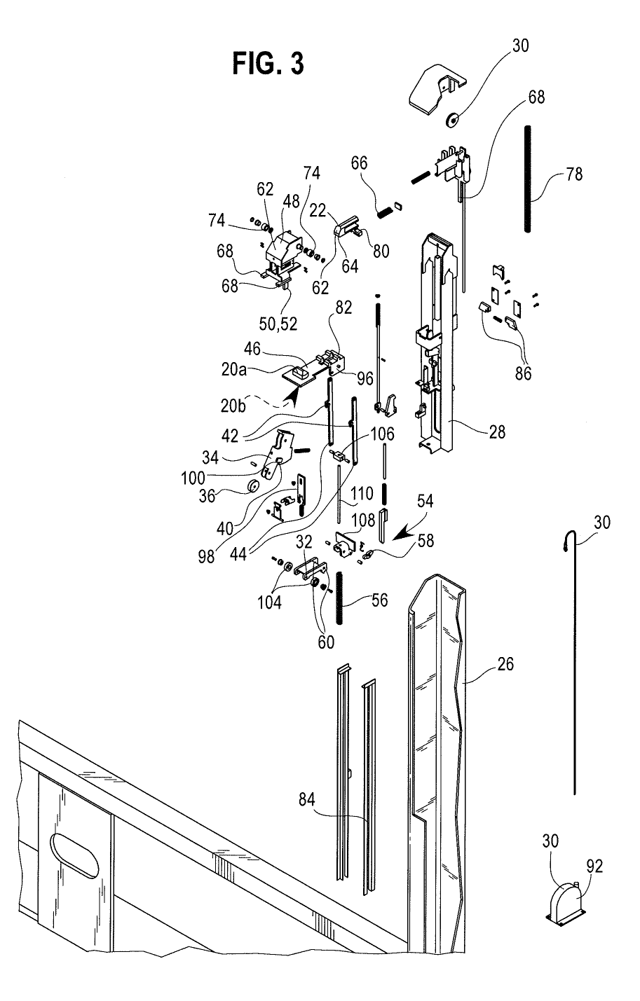

Referring now to FIGS. 2 and 3, the connector system 10 utilizes the combination of connecting pins 20a, 20b and a locking pin 22 to couple the lower and upper containers 12, 14. The connecting pins 20a, 20b and the locking pin 22 each may take the form of a connector pin that may be inserted into the predetermined connecting points 18 where the containers meet such as corning castings or castings at another point along the edge of the of the lower and upper containers 12, 14. The connector system 10 inserts and holds the connecting pins 20a, 20b in place such that the lower and upper containers 12, 14 are stably coupled together during transport, but the containers may be easily removed by a lifting device, frequently referred to as a spreader 24. An example spreader may be the Pin Plus, or another PIN WTP and ISO standard latch system.

The connector system 10 is comprised of a housing 26 that extends from a side of the rail car 16 and, in particular, a railway well car that is used to transport shipping containers. The example discussed throughout this description considers the connector system 10 in an embodiment including a railway well car. However, in an alternative embodiment, the connector system 10 may also be incorporated along the side of a buffer. A buffer is a station or containment space with moveable shelves where containers can be exchanged with a high degree of automation. Further, in alternative embodiments, the connector system 10 may be included on the chassis of a tractor-trailer, or any other location where connecting stack containers would be advantageous.

As shown in FIGS. 2 and 3, a frame 28 is positioned within the housing 26. The frame 28 is movable in a vertical direction and, in one embodiment, is coupled to a counterbalance pulley system 30. In an embodiment, the frame 28 and housing 26 of the connector system 10 are removably attached to the side of the rail car 16. Also in an embodiment, the frame 28 and housing 26 of the connector system 10 are pivotably mounted to the side of the rail car 16.

In an initial position, a return mechanism lever (return lever) 32 and a lifting device locating lever (locating lever) 34 extend outward, distal from the frame 28, past the plane of the housing 26 on the interior side of the connector system 10. The return lever 32 and the locating lever 34 are the portions of the connector system 10 that first make contact with the lower and upper containers 12, 14. The return lever 32 and the locating lever 34 also are the first portions of the connector system 10 that make contact with the spreader 24.

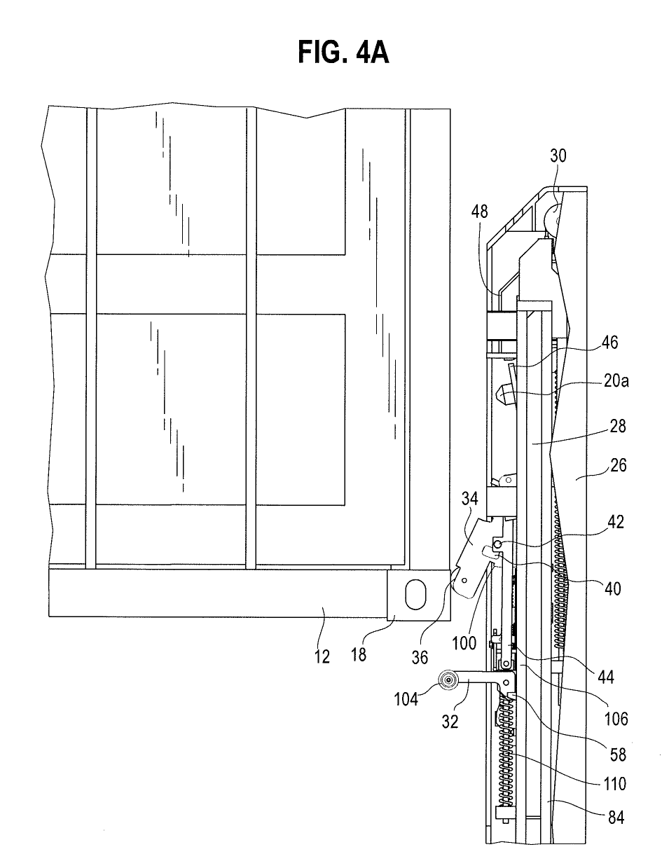

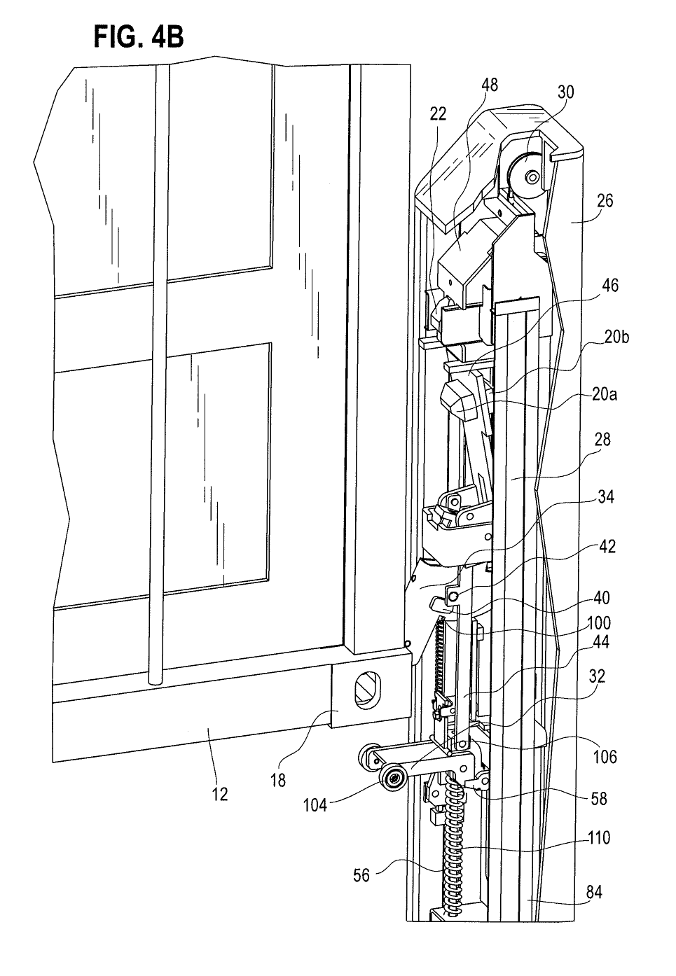

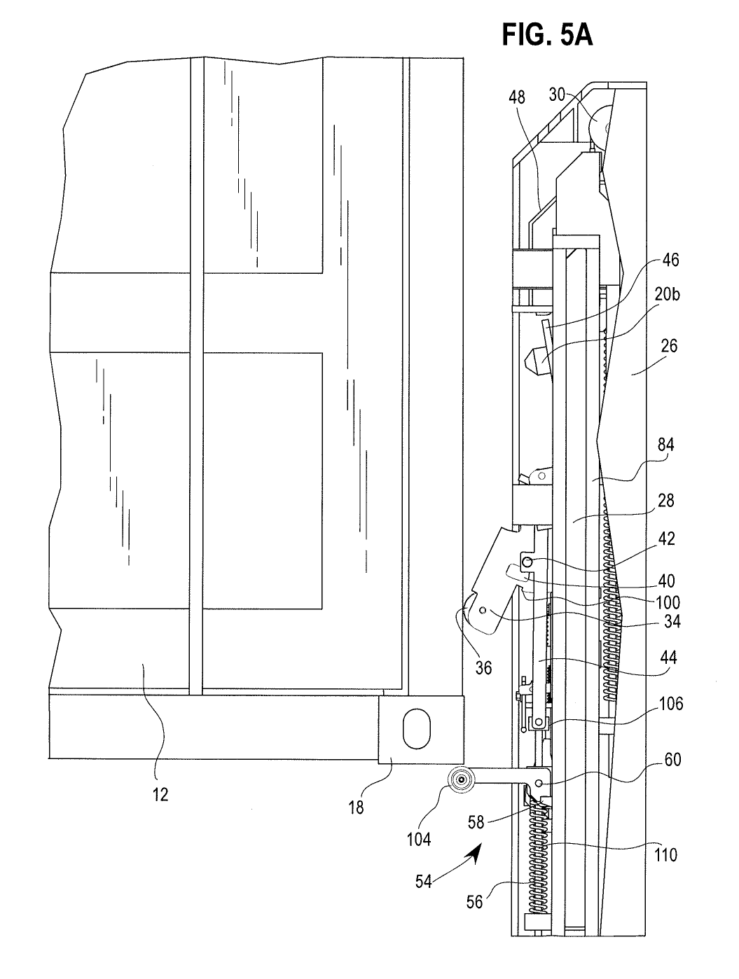

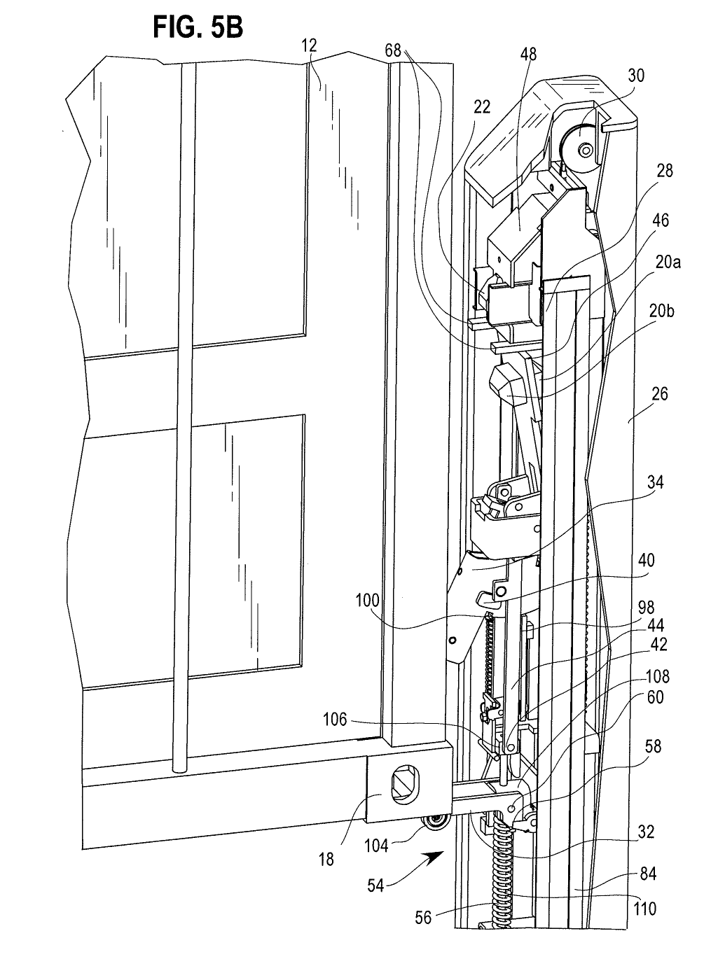

Referring now to FIGS. 4A, 4B, 5A, and 5B, the lower container 12, or first container, is seen as it is placed onto the rail car 16. The locating lever 34 and the return lever 32 are positioned in the path of the lower container 12 as it is being lowered. The lower container 12 contacts the locating lever 34 first, as seen in FIGS. 4A and 4B. Then the lower container 12 next contacts the return lever 32, as seen in FIGS. 5A and 5B.

As shown in FIG. 2, in one embodiment, the locating lever 34 extends distal to the frame 28 at an angle of less than 90° with respect thereto, in an initial, resting position. The locating lever 34 contacts the outer surface of the lower container 12 and is slightly depressed towards the frame 28 to a second, retracted position as shown in FIGS. 4A and 4B as the lower container 12 is placed into the well 38 of the rail car 16 by the spreader 24. The locating lever 34 has a roller 36 on an end that contacts the containers 12, 14 and spreader 24. The locating lever 34 may determine when the lower and upper containers 12, 14 are currently being lowered into the containment cavity 38 of the rail car 16. Further, the locating lever 34 may track whether the spreader 24 remains in the well 38 or has been removed. The well 38 of the rail car 16 may alternatively be referred to herein as a containment cavity 38. In an embodiment, the containment cavity 38 is located within a buffer or another place where a container might be stored, such as a truck chassis.

When the locating lever 34 is in its initial position flanges (locating lever flanges) 40 located on either side of the locating lever 34 provide support to corresponding flanges (arm flanges) 42 located on the coupler plate positioning arms 44, as seen in FIG. 2. Referring now to FIGS. 4A and 4B, during depression of the locating lever 34 the movement of the locating lever 34 permits the flanges 42 of the coupler plate positioning arms 44 to slide past the locating lever flanges 40. The coupler plate positioning arms 44 are retained in their initial position until the spreader 24 is removed following placement of the lower container 12 in the containment cavity 38.

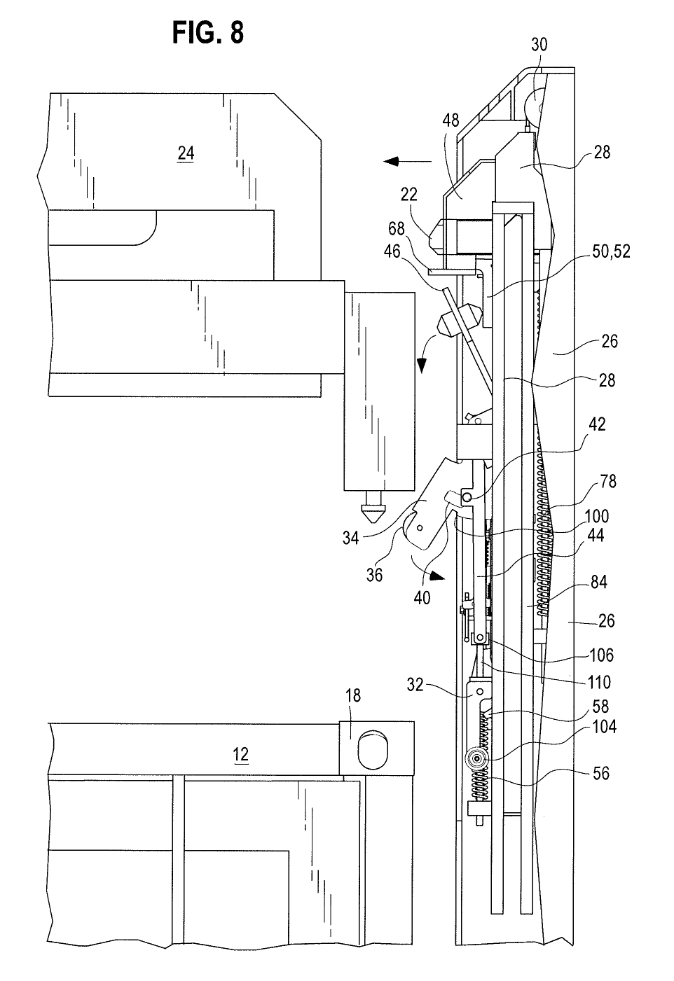

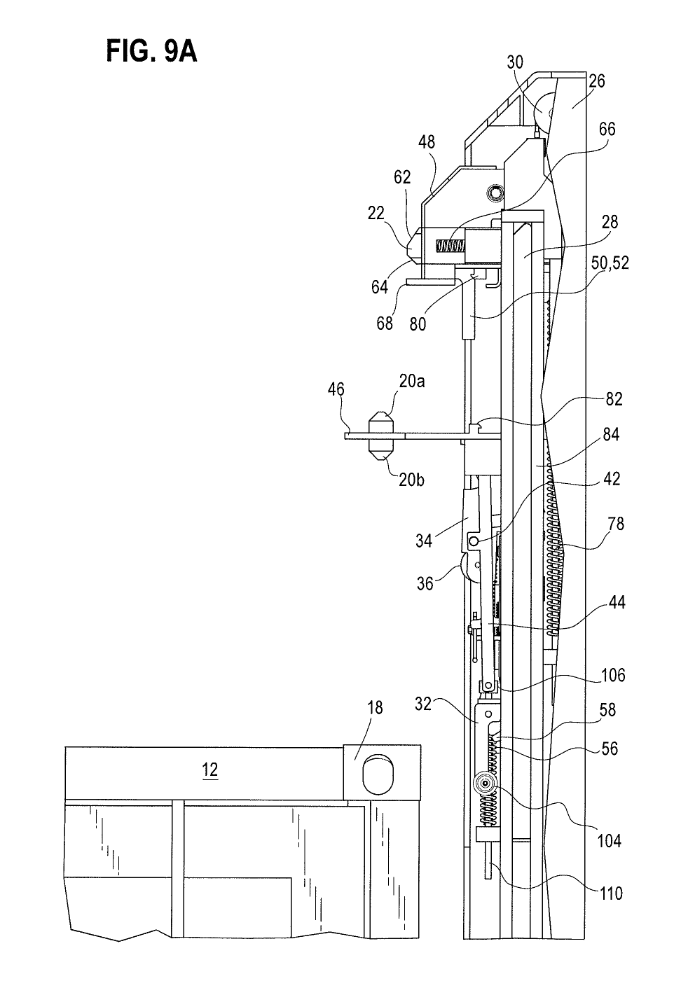

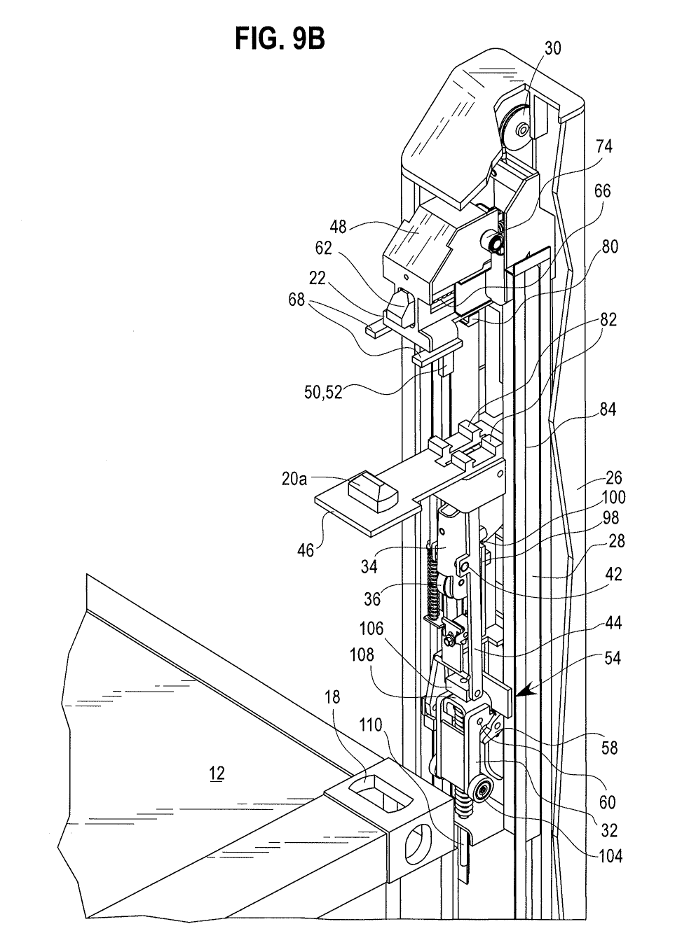

Referring ahead to FIG. 8, once the spreader 24 passes by the locating lever 34 (during removal of the spreader 24) and therefore ceases to hold the locating lever 34 in the depressed position. Thus the locating lever 34 springs out briefly after the spreader 24 is removed from the containment cavity 38. Once the locating lever 34 springs forward briefly, the now unsupported coupler plate positioning arms 44 are released. In turn, upon release of the coupler plate positioning arms 44 by the locating lever 34, the coupler plate positioning arms 44 release the coupler plate 46. The coupler plate 46, which begins in a tucked position along the frame 28, stowed inside or nearly inside the housing 26, as shown in FIG. 2, then falls forward to a horizontal position perpendicular to the frame 28 and housing 26, seen in FIGS. 9A and 9B. Likewise, after releasing the coupler plate positioning arms 44 and thereby releasing the coupler plate 46, the locating lever 34 is immediately pushed into its retracted position, tucked within the housing 26, when the coupler plate 46 falls forward.

Arranged above the coupler plate 46 is a locking housing 48, as seen in FIGS. 2 and 3. The components included in the locking housing 48 are discussed in detail below, but the locking housing 48 at least includes the locking pin 22. The locking housing 48 may be spring loaded such that when the locking housing 48 is deployed a spring pushes the locking housing 48 from an initial, retracted position, as seen in FIG. 2, tucked against the frame 28 to a second, extended position distal to the frame 28 and housing 26.

The coupler plate 46 falls forward from gravity but is assisted by the spring loaded action of the locking housing 48. The coupler plate 46 is released when a spring behind the locating lever 34 pushes the locating lever 34 briefly back towards a forward position distal to the frame, as discussed above. Further, locating lever flanges 40 contact coupler plate positioning arm flanges 42 that protrude from the coupler plate positioning arms 44. The coupler plate positioning arms 44 operatively couple the coupler plate 50 to the return spring 56. The lower ends of the coupler plate positioning arms 44 have pinned therebetween a return spring block 106. The return lever 32 is connected to a return spring bracket 108. When the coupler plate positioning arms 44 are released the return spring block 106 is positioned thereby on top of the return spring bracket 108 that, in turn, is positioned on top of the compressed return spring 56. A guide rod 110 runs vertically through the return spring 56, return spring bracket 108, and return spring block 106.

In the initial position, the return spring 56 pushes up on the return spring bracket 108 that, in turn, pushes up on the return spring block 106. Then, by way of the return spring block 106, the coupler plate positioning arms 44 hold the coupler plate 46 in the stowed position. The coupler plate 46 holds the locking housing 48 in the stowed position by way of the locking housing retention arm 52. Initially, the locating lever flanges 40 contact the coupler plate positioning arm flanges 42, preventing the coupler plate positioning arms 44 from descending. Further, the return lever 32 may be pinned to the return spring bracket 108.

The initial, horizontal position of the return lever 32 is maintained by the return lever flanges 58 that hold the return lever 32 in place with torsion. When the container 12 depresses the return lever 32 the return spring bracket 108 compresses the return spring 56. A gap develops between the return spring block 106 and the return spring bracket 108 because the locating lever 34 is blocking the motion of the coupler plate positioning arms 44. Once the downward motion of the container has forced the return lever 32 downward enough to load the return spring 56, the return spring bracket 108 is latched in place to retain compression of the return spring 56. Once the return spring bracket is latched in place, the return lever flanges 58 release the return lever 32 and drop the return lever to its tucked position.

Referring ahead now to FIG. 8, an arrow illustrates the motion of the locking housing 48 as it is propelled to its deployed position. The second, extended position of the locking housing 48 may be seen in FIGS. 9A and 9B. In one example, the locking housing 48 is released from its initial position by the locating lever 34. In such an embodiment, the locking housing 48 may extend to its deployed position, distal to the frame 28, in response to the spreader 24 passing by the locating lever 34 and therefore ceasing to contact the locating lever 34 as shown in FIG. 8.

Further, the locking housing 48 may include a coupler plate deployment arm 50 extending downward from the locking housing 48 and shown in FIGS. 3, 8, 9A, and 9B. The coupler plate deployment arm 50 may apply pressure to the coupler plate 46 when the coupler plate 46 is in its initial, tucked position substantially within the housing 26. In certain embodiments, the coupler plate deployment arm 50 may push the coupler plate 46 from within the housing 26 such that the coupler plate 46 pivots along a hinged end and deploys to the horizontal position. The coupler plate 46 is distal to the frame 28 and housing 26 when in the deployed position.

In an alternative embodiment, the coupler plate deployment arm 50 may instead function as a locking housing retention arm 52. The locking housing retention arm 52 may extend downward from the locking housing 48 and be retained by the coupler plate 46 when the coupler plate 46 is in the retracted position. The release of the coupler plate positioning arms 44 by the locating lever 34 releases the coupler plate 46 and thus releases the locking housing retention arm 52. The coupler plate 46 is deployed in response to the locating lever 34 detecting the placing of the lower container 12 in the containment cavity 38. Release of the locking housing retention arm 52 may allow the spring-loaded locking housing 48 to extend to its second, extended position.

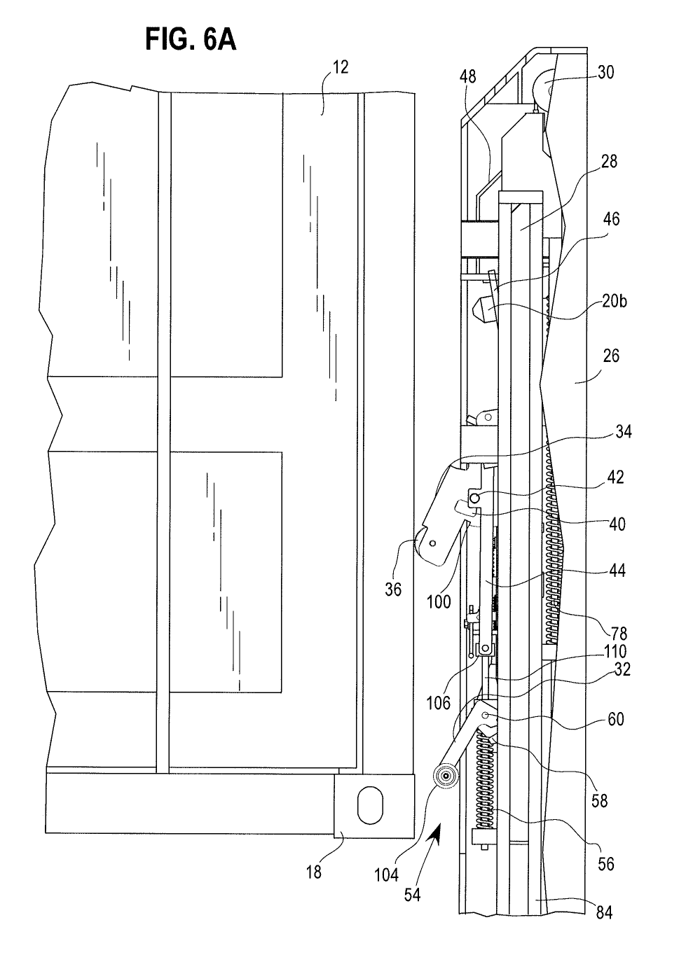

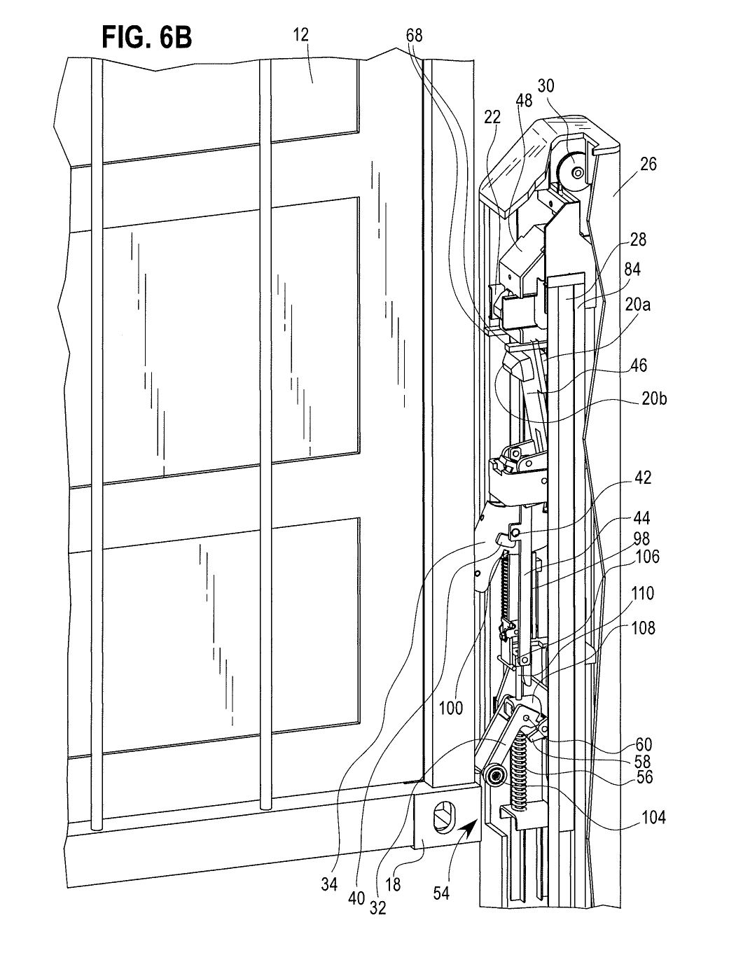

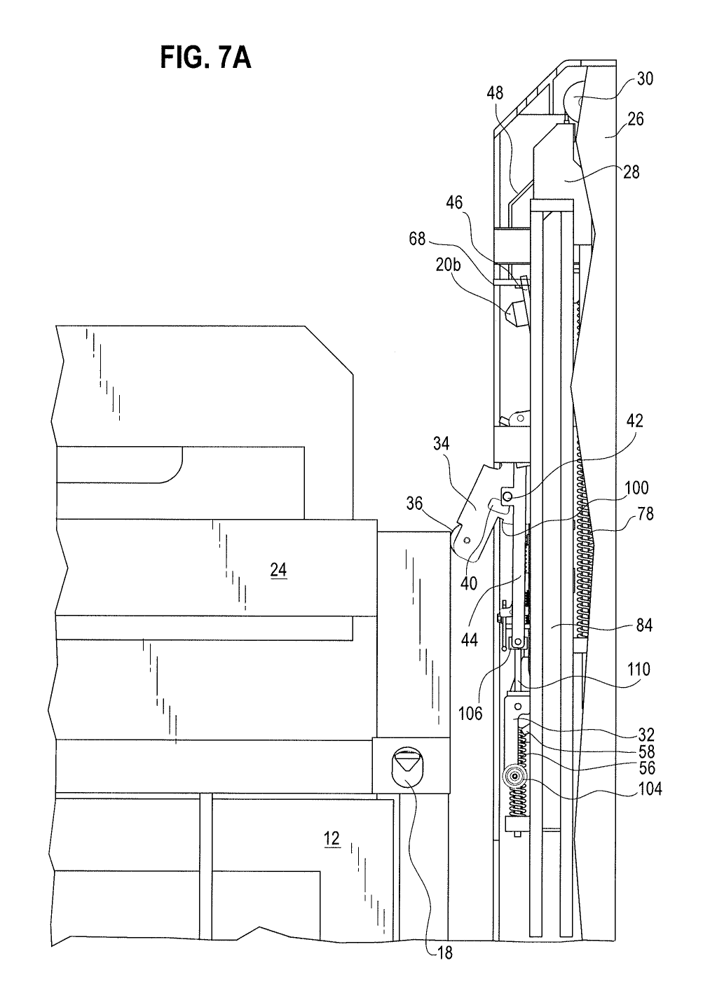

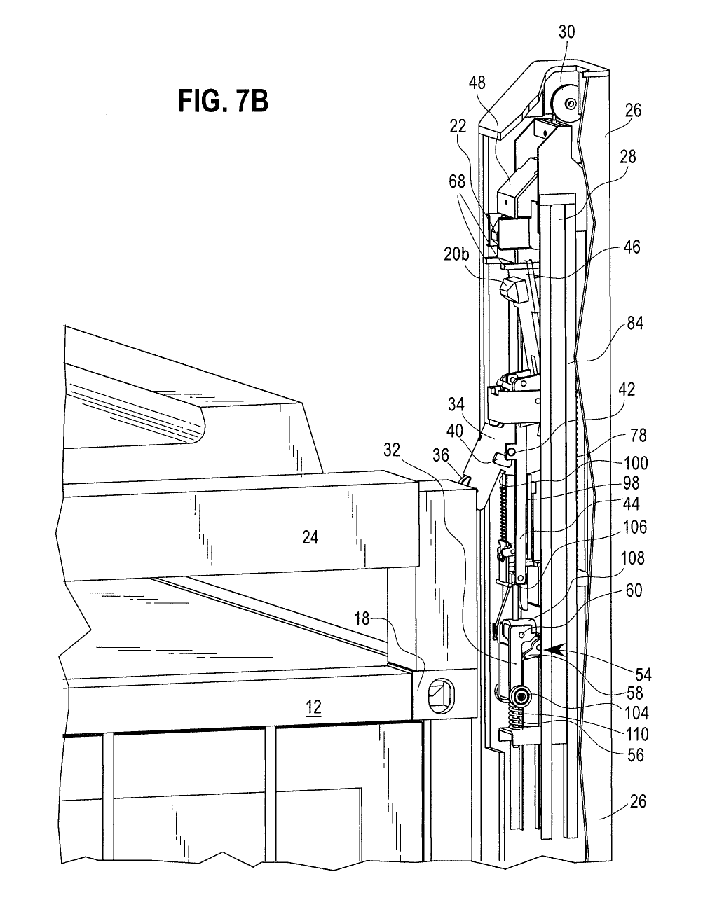

Referring now to FIGS. 6A, 6B, 7A, 7B, and 8, the locating lever 34 is depressed but maintains contact through the locating roller 36, with the lower container 12 (FIGS. 6A and 6B) and spreader 24 (FIGS. 7A and 7B), but then springs out briefly after the spreader 24 is removed from the containment cavity 38 and is immediately pushed into its retracted position when the coupler plate 46 falls forward. An arrow in FIG. 8 illustrates the motion of the locating lever 34 as it proceeds to its retracted position tucked against the frame 28. As shown in FIGS. 6A and 6B, the locating lever 34 senses the loading of the lower container 12, i.e. the first container, into the containment cavity 38 as well as the entry of the spreader 24 into the containment cavity 38 (as shown in FIGS. 7A and 7B). In embodiments, one or both of the return lever 32 and/or the locating lever 34 may include a lever that is coupled to the frame 28 and/or the housing 26. The lever(s) may be coupled to the frame 28 and/or housing 26 at an axis of rotation and extend outwardly therefrom in a horizontal direction distal to the frame 28 while in an initial, starting position.

In contrast, the return lever 32, which has an initial position distal to the frame, snaps into a retracted position once contact is made between the lower container 12 and the return lever 32 as depicted in FIGS. 6A and 6B. The retracted position of the return lever 32 is tucked against the frame 28 within, or nearly within, the housing 26. Following initiation of contact between the return lever 32 and the lower container 12, the return lever 32 is retained in the retracted position by a return spring locking mechanism 54. The return lever 32 pushes the return spring locking mechanism 54 downwards compressing the return spring 56. In an example embodiment, the return lever 32 maintains a horizontal direction as it moves vertically from the first position to the second position against the bias of the return spring 56, and subsequently rotates about an axis of rotation as the lower container 12 continues moving downward.

Once the return spring 56 has been sufficiently compressed, the return spring locking mechanism 54 locks the return spring 56 in the compressed position and releases two flanges, one on either side of the return lever (return lever flanges) 58. Upon release of the return lever flanges 58, the return lever 32 pivots on hinges (return lever hinges) 60 coupled to the frame 28 and falls under force of gravity to a position parallel to the frame 28 and housing 26, shown in FIGS. 8, 9A, and 9B. After compressing the return spring 56, the return lever 32 is retained inside the housing 26 and out of the path of the lower container 12.

Once the first, lower container 12 has been placed in the containment cavity 38 and the spreader 24 has been removed, both the return lever 32 and the locating lever 34 are in their retracted positions tucked against the frame 28 and the housing 26. At this point, as depicted in FIGS. 9A and 9B, the coupler plate 46 and the locking housing 48 have been deployed to their second positions extending perpendicular to the frame 28 and past the plane of the housing 26. In their extended positions, the coupler plate 46 and the locking housing 48 are arranged to contact the upper container 14 and effect coupling of the lower and upper containers 12, 14.

In an embodiment shown at least in FIGS. 9A and 9B, the coupler plate 46, as previously described, has a first end 38 attached to the frame 28 of the connector system 10 and a second end distal to the frame 28 when in the deployed position. Further, second end has formed thereto the two connecting pins 20a, 20b; the first connecting pin 20a extending from the top of the coupler plate 46 and the second connecting pin 20b extending from the bottom of the coupler plate 46. The coupler plate 46 and connecting pins 20a, 20b may include a connecting system such as that described in patent application Ser. No. 14/516,050 (Attorney Docket No.: C0443/40687—“Self-Latching Interbox Connector for Automatic Securement of a Top Container to a Bottom Container”). Variations on the exact connection configuration may exist, but the connecting pins 20a, 20b, and the coupler plate 46 develop and maintain a connection between the lower and upper containers 12, 14. Specifically, Association of American Railroads (AAR) specifications are used to determine the maximum force needed to engage the locking pin 22 and the range of force needed for activation of release of the locking pin 22.

Further shown at least in FIGS. 9A and 9B, the locking housing 48 carries a locking pin 22. The locking pin 22 is contained within the locking housing 48, and when the locking housing 48 is deployed the locking pin 22 is positioned to align with one of the connecting points 18 of the upper container 14. The locking pin 22 may be spring loaded such that the locking pin 22 extends out through an opening in the locking housing 48. Both the locking housing 48 and the locking pin 22 itself may have an angled upper surface 62 such that when the upper container 14 is lowered into the rail car 16 it may strike the angled upper surface 62 and cause the locking housing 48 to retract towards the frame 28.

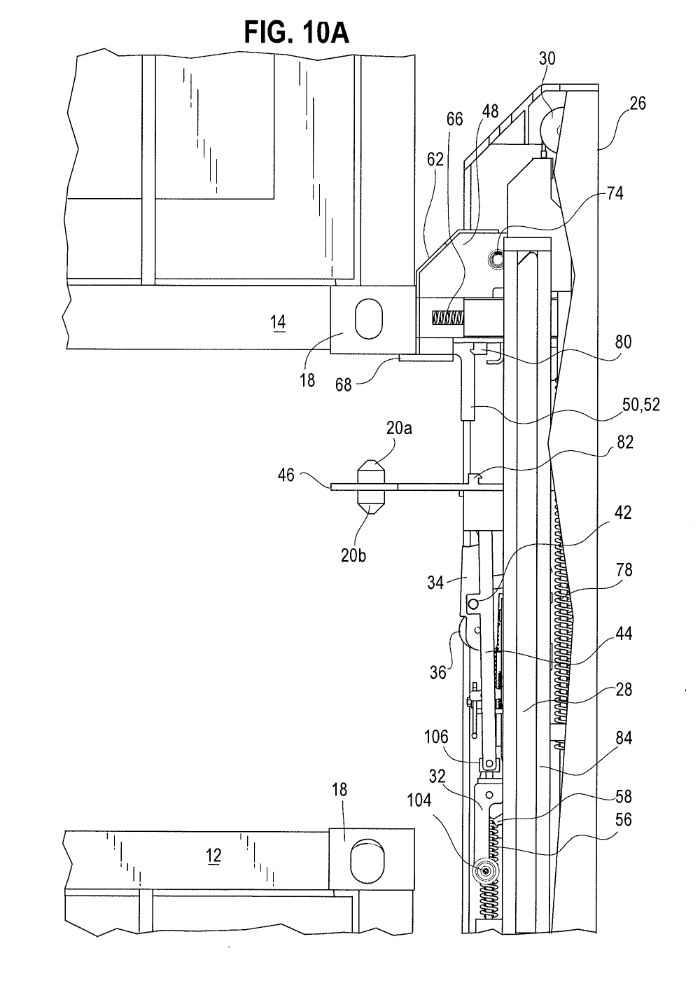

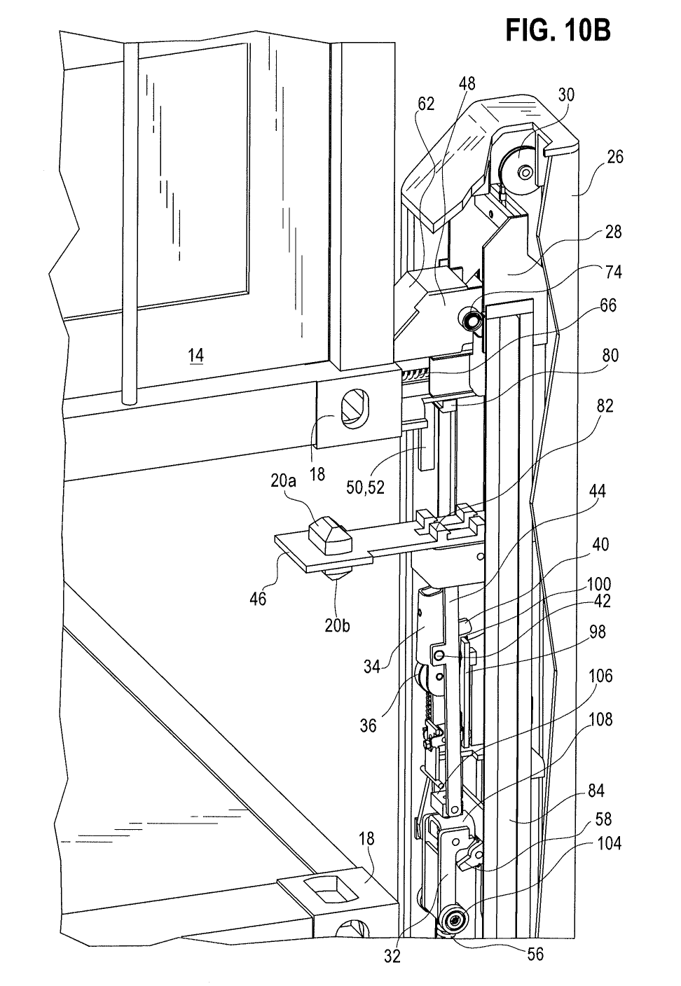

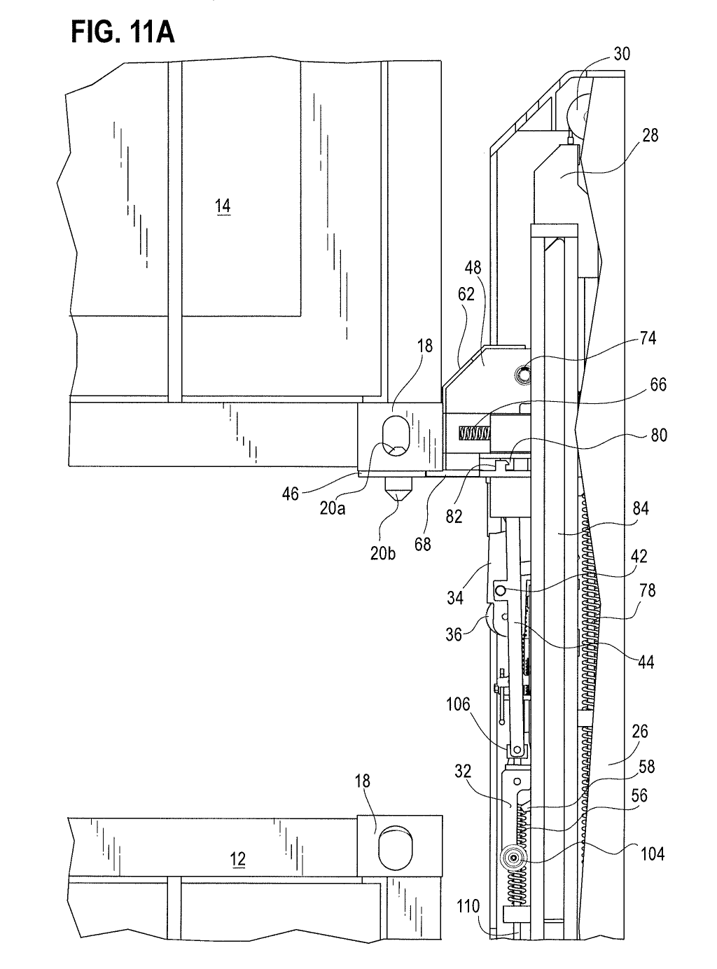

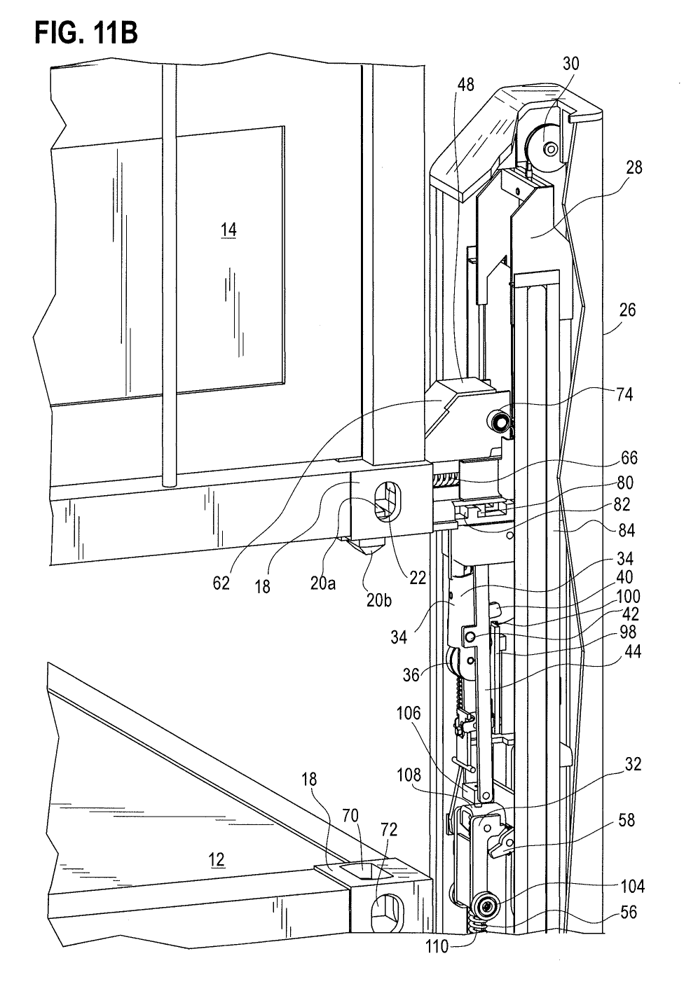

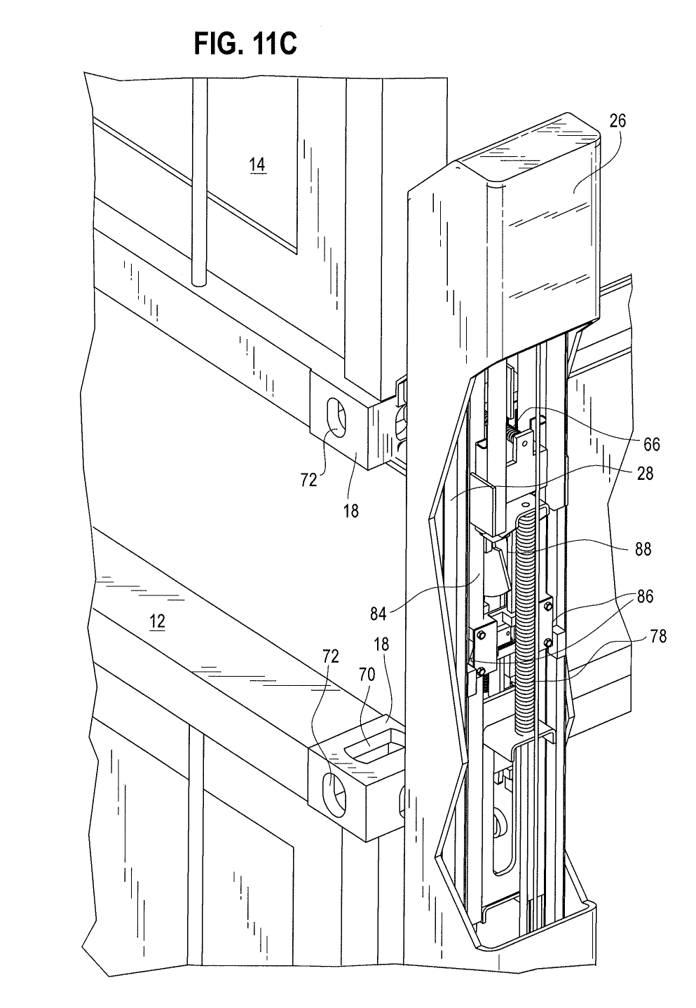

In the embodiment as shown in FIG. 9A, the locking pin 22 has angled upper 62 and lower surfaces 64 that converge to a flat, front face. The angled upper and lower surfaces 62, 64 act as a cam or guide surface for the edges of the upper container 14 and the respective connecting points 18, such as a corner casting thereon. The edges of the upper container 14 at the connecting points 18 ride along angled upper and lower surfaces 62, 64 during the loading or unloading operations, thereby allowing the locking pin 22 to be seated or unseated within the corner casting, as required. Prior to positioning the upper container 14 in the rail car 16, the locking housing is spaced apart from the coupler plate 46 as shown in FIGS. 9A, 9B, 10A, and 10B. The upper container 14 contacts an upper angled surface 62 of the lock housing 48 (FIGS. 10A and 10B) as it is lowered into the containment cavity 38 thereby causing the locking housing 22 to move downward onto the coupler plate 46 as shown in FIGS. 11A and 11B.

How the upper container 14 makes contact with the angled upper surface 62 of either the locking pin 22 or the locking housing 48 may be determined by the width of the container. When the upper container 14 is ninety-six inches wide the angled upper surface 62 of the locking pin 22 may be the first place said container makes contact. However, when the upper container 14 is one-hundred-two inches wide the locking housing 48 is contacted first and caused to retract before the upper container 14 is permitted to make contact with the angled upper surface 62 of the locking pin 22.

As the upper container 14 is lowered, retraction of the locking pin 22 permits the container 14 to move past the locking pin 22 and contact the shelf flange 68 of the locking housing 48, shown in FIGS. 9A and 9B, as well as the coupler plate 46. The shelf flange(s) 68 of the locking housing 48 may include a single flange or multiple flanges. The shelf flange(s) 68 fit in or along the coupler plate 46 to produce a flush surface in conjunction with the coupler plate 46. The flush surface created by the coupler plate 46 and the locking housing shelf flange(s) 68 forms the coupling surface between the lower and upper containers 12, 14.

Referring now to FIGS. 10A, 10B, 11A, and 11B, the lower and upper containers 12, 14 are coupled together the connecting points 18 such as a corner casting or alternatively another standard ISO casting located along the side of the container but not necessarily at the corner. In some embodiments, the connecting points 18 may even be spaced apart from the edges of the container, instead located interior along a top or bottom surface of the container. The connecting points 18 whereby the lower and upper containers 12, 14 are coupled to one another have vertical connecting points 70 into which connecting pins (such as connecting pins 20a, 20b) oriented vertically may be inserted, and horizontal connecting points 72 into which connecting pins 18 (such as locking pin 22) oriented horizontally may be inserted.

When containers forty feet long by ninety-six inches wide are loaded into the rail car and coupled together by the connector system 10, corner castings serve as the connecting points 18 for the coupler plate 46 and the connecting pins 20a, 20b extending therefrom (as seen and described with reference to FIGS. 10A, 10B, 11A, and 11B). In embodiments having containers fifty-three feet long by one-hundred-two inches wide a standard casting along the side of the container may be used as the connecting point 18. The side standard casting of a one-hundred-two inch wide container may have the vertical connecting point 70 spaced apart from the edge of the container and interior to the top or bottom surface of the container while the horizontal connecting point 18 may be located at the container edge. This is in contrast to a container ninety-six inches wide that has the vertical and horizontal connecting points 18 located adjacent to one another on a corner casting.

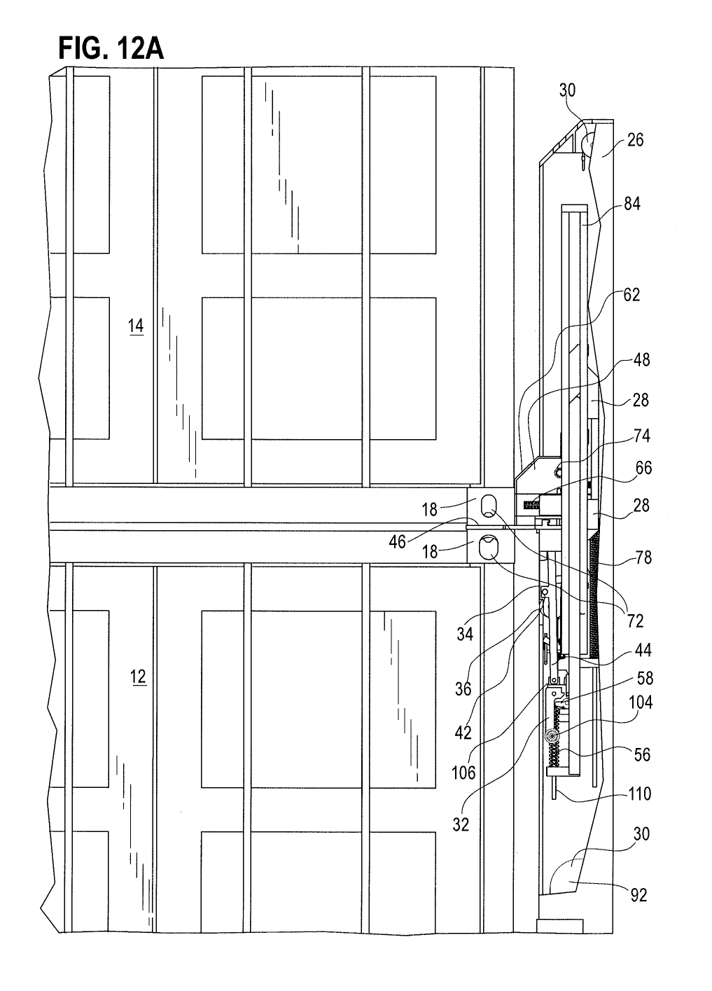

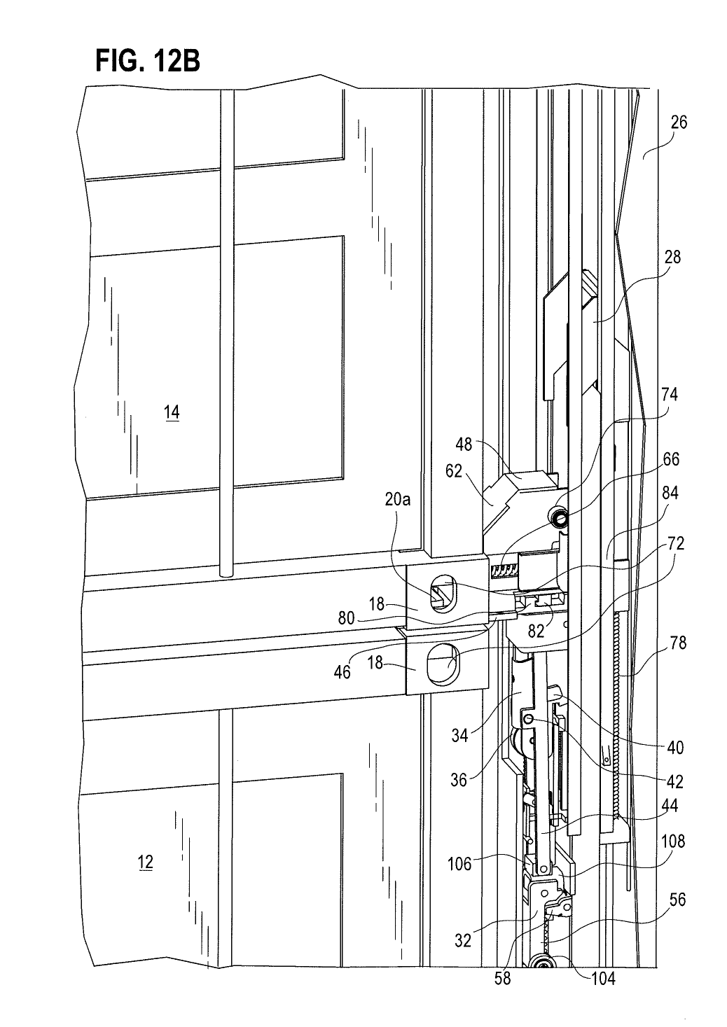

The relative positioning of the shelf flange(s) 68 and the coupler plate 46 changes with the width of the containers being loaded into the rail car 16. When the containers have a width of ninety-six inches and the coupling takes place at a corner casting with connecting points 18 adjacent to one another, the shelf flange(s) 68 fit closely with the portion of the coupler plate 46 surrounding the connecting pins 20a, 20b, as seen in FIG. 11A. In this example embodiment shown in FIGS. 12A and 12B, the coupler plate 46 and the shelf flange(s) 68 are both sandwiched between the corner casting of the upper, second container 14 and the corner casting of the lower, first container 12 during connection. In this way, the surfaces of the coupler plate 46 and the shelf flange(s) 68 form the coupling surface in conjunction.

In an alternative embodiment, when the containers being loaded have a width of one-hundred-two inches the coupling may take place at a standard casting located some distance from the corner/edge of the container along the side of the container, as described above. When one of the connecting points 18 is spaced apart from the side of one of the containers, the coupler plate 46 is sandwiched between top and bottom surfaces of the lower and upper containers 12, 14 respectively while the shelf flange(s) 68 are sandwiched between casting surfaces on the edges of the lower and upper containers 12, 14.

Referring again to FIGS. 11A and 11B, the force exerted on the locking pin 22 causes the locking housing 48 and the entirety of the locking mechanism therein to move down along the frame of the connector system 10. Rollers 74 retain the locking housing 48 in a locking housing track 76 along the frame 28 of the container connector system 10. As the locking housing 48 is pushed downward the length of the frame 28, a locking housing return spring 78 is compressed by an interior portion of the locking housing 48, as seen in FIG. 11C. The container 14 exerts force on the angled upper surface 62 of the locking pin 22 and moves the locking housing 48 downward while compressing the locking housing return spring 78 until the locking housing 48 meets the coupler plate 46.

Referring still to FIGS. 11A and 11B, the shelf flange(s) 68 fits on either side of the coupler plate 46 and creates a flush coupling surface when the bottom of the locking housing 48 meets the top of the coupler plate 46. The coupler plate 46 provides resistance to the descending locking housing 48 and upper container 14. Upon encountering this resistance, the casting of the upper container 14 overcomes the force of the locking pin spring 66 that holds the locking pin 22 out from the locking housing 48. The casting pushes against the angled upper surface 62 of the locking pin 22 forcing the locking pin 22 to retract inside the locking housing 48.

The locking pin 22 may have a latching mechanism 80 on a second end of the locking pin 22 spaced apart from a first end of the locking pin 22 that carries the connecting pin 20c. Referring still to FIGS. 11A and 11B, but also to the exploded view of FIG. 3, a counterpart latch 82 to the latching mechanism 80 may be located on an end of the coupler plate 46 spaced apart from the distal end of the coupler plate 46 wherefrom the connecting pins 20a, 20b extend. The retraction of the locking pin 22 pushes the latching mechanism 80 past the counterpart latch 82 on the coupler plate 46. When the edge of the casting has pushed past the locking pin 22, the horizontal connecting point 72 of the casting aligns with the locking pin 22. The locking pin 22 extends out from the locking housing 48 under spring power and into the casting through the horizontal connecting point 70. Upon the re-extension of the locking pin 22, the latching mechanism 80 engages with the counterpart latch 82 of the coupler plate 46. The locking pin 22 and locking housing 48 are thereby attached to the coupler plate 46.

Once the locking housing 48 has been moved downward until attached to the coupler plate 46, the locking housing 48 has reached the end of the locking housing track 76 provided for it within the frame 28. At this point, the upper container 14 is coupled to the locking housing 48 by insertion of the locking pin 22 into the horizontal connecting point 72, and the upper container 14 is coupled to the coupler plate 46 by way of the upper connecting pin 20a. Thus, the upper container 14 has descended to the point of the coupler plate 46 and been attached to the coupler plate 46 and locking housing 48 but, nevertheless, the upper container 14 has not yet reached the lower container 12. For the upper, second container 14 to continue descending down to the position of the lower, first container 12 the coupler plate 46 must likewise descend.

Referring now to FIGS. 12A and 12B, the frame 28 of the container connector system 10 may be able to slide along the track 84 provided in the housing 26. However, before the upper container 14 pushes the locking housing 48 into attachment with the coupler plate 46, the frame 28 is held in place within the housing 26 by a spring loaded wing latch release 86 (seen in FIG. 11C). A release arm 88 positioned at the interior of the locking housing 48 contacts the wing latch release 86 in response to attachment of the locking housing 48 to the coupler plate 46. The release arm 88 pushes the wing latch release 86 thereby retracting the wings of the wing latch. Upon retraction of the wings of the wing latch release 86, the frame 28 is released and capable of moving freely along the track 84.

Once the frame 28 is released, the upper container 14 may push the frame 28 down along the track 84, by way of downward force on the coupler plate 46. Thus, the upper container 14 may continue descending into the containment cavity 38. The frame 28 may further be connected to a pulley system 30. The pulley system 30 may include a spring-loaded reservoir 92 of pulley cable. The pulley cable reservoir 92 may be located in the bottom of the housing 26 or at another suitable location. When the frame 28 is forced to move down along the housing 26 by the descending upper container 14 reserve pulley cable may be released from the reservoir 92. As described in further detail below, the pulley cable extracted from the reservoir 92 may aid the frame 28 in returning to its original position following the removal of the upper container 14 from the rail car 16.

Once the locking housing 48 contacts the coupler plate 46, the upper connecting pin 20a is seated in the bottom of the corner casting of the upper container 14. As the upper container 14 continues to be lowered into the containment cavity 38, it forces the frame 28 downward (see FIGS. 12A and 12B), thereby causing the coupler plate 46 to move down until the lower connecting pin 20b is seated in the corner casting of the upper corner of the lower container 12. Once both connecting pins 20a, 20b are seated, the locking pin 22 extends outward from the locking housing 48 into the corner casting on the upper container 14, thereby locking both the lower and upper containers 12, 14 together and securely in place in the containment cavity 38.

Locking from the top and bottom as well as the side may provide a secure connection between the lower and upper containers 12, 14. Alternatively, the connecting of the lower and upper containers 12, 14 may be provided by a twistlock locking mechanism or inter-box connector mechanism incorporated into the coupler plate 46. In a further alternative embodiment, twistlock or another locking mechanism incorporated into the coupler plate 46 may securely connect the lower container 12 and upper container 14 while the locking pin 22 is omitted entirely.

Once securely connected, the upper container 14 rests on top of the lower container 12 with the coupler plate 46 therebetween. The upper and lower connecting pins 20a, 20b, along with the locking pin 22, prevent horizontal motion of the containers 12, 14. Only the removal of the upper container 14 by the spreader 24 may decouple the containers. When the upper container 14 is resting on the lower container 12 and the containers are securely connected, the rail car utilizing the connector system 10 is ready to transport the containers.

After completion of transport, or when the containers are otherwise ready to be disconnected and removed from the containment cavity 38, the spreader 24 may be deployed to raise the upper container 14. The same spreader 24, or a spreader associated with a different location or purpose, such as a spreader unloading rail cars at the intended destination of the containers, may be used. As the upper container 14 is lifted out of the containment cavity 38 by the spreader 24, the lower connecting pin 20b is extracted from the vertical connecting point 70 of the lower container 12. The upper container 14 remains attached to the coupler plate 46 and locking housing 48 by way of the combination of the upper connecting pin 20a and the locking pin 22. The edge of the casting exerts upward force on the angled bottom surface 64 of the locking pin 22. The latching mechanism 80 of the locking pin 22 continues to engage with the counterpart latch 82 of the coupler plate 46. Thus, by way of the upward force of the casting on the locking pin 22, the return mechanism causes the locking pin 22, locking housing 48, and the coupler plate 46 attached to the locking pin 22 to move upwards.

Likewise, the frame 28 of the connector system 10 rises along the track 84 provided within the housing 26. The rise of the entirety of the frame 28 and the components carried thereon may be aided by the retraction of the counter balance pulley 30. The counter balance pulley reservoir 92 retracts the length of pulley extracted during the descent of the frame 28, thereby the return mechanism pulls the frame 28 upwards along the track 84 and back to the initial position of the frame 28 within the housing 26.

When the frame 28 reaches the end of the track 84 it has returned to its initial position and may be stopped from progressing further upwards by the end of the track 84 or by the top of the housing 26. The coupler plate 46 is fixedly attached to the frame 28 and ceases moving upwards when the frame 28 reaches its initial position. Once the coupler plate 46 stops moving upwards, the force produced by the edge of the casting on the angled bottom surface 64 of the locking pin 22 overcomes the spring 66 that extends the locking pin 22 out from the locking housing 48. The locking pin 22 retracts and the locking pin spring 66 is compressed. When the locking pin 22 is retracted, the latching mechanism 80 on the locking pin 22 unlatches from the counterpart latch 82.

After the coupler plate 46 and the locking pin 22 are detached, the locking pin 22 and locking housing 48 continue to be propelled upwards by the return mechanism. Specifically, the return mechanism includes the locking housing return spring 78, which is initially loaded during the descent of the upper container 14. The locking housing 48 and locking pin 22 reach the top of the housing 48 and return to their initial resting position tucked against the frame 28.

While the locking housing 48 and locking pin 22 are returning to their initial position, the return mechanism likewise retracts the coupler plate 46 into its initial position tucked against the frame 28, within the housing 48, underneath the locking housing 48, and realigned with the coupler plate deployment arm 50 that extends downward from the locking housing 48. As described above, the return lever 32 is operatively coupled with the coupler plate 46 by the coupler plate positioning arms 44. The return lever 32 is pushed down by the descent of the lower container 12 during the placement of the containers in the containment cavity 38 of the rail car 16 and the return spring 56 is compressed. The coupler plate positioning arms 44 maintain an operative coupling to the return lever 32 during the time that the coupler plate 46 is deployed. Once the locking housing 48 no long holds the coupler plate 46 in its extended position horizontal to the housing 26, the return spring 56 may manipulate the coupler plate 46 into retracting. The return spring 56 expands causing the return lever 32 to extend out to its initial position while conjointly pushing the coupler plate positioning arms 44 upward.

The coupler plate positioning arms 44 are operatively coupled to the coupler plate 46. When the coupler plate positioning arms 44 are pushed upward by the return spring 56 and return lever 32, the coupler plate positioning arms 44 exert an upward force on a pivot hinge of the coupler plate 46. In reaction to the force of the coupler plate positioning arms 44, the coupler plate 46 pivots on the hinge 96 that holds the coupler plate 46 within the housing 26. As the coupler plate 46 pivots, it retracts back to its initial position tucked against the frame 28. At this point, the upper container 14 has been fully removed from the containment cavity 38 of the rail car 16, the locking housing 48 and coupler plate 46 have been retracted to their initial positions by the return mechanism, and the return lever 32 has been redeployed. The return lever 32 is held in a partially extended position by the lower container 12 that remains in the containment cavity 38. The return lever rollers 104 contact the side of the lower container 12.

Following removal of the upper container 14, the spreader 24 may return to remove the lower container 12 from the rail car 16. As the spreader 24 begins lifting the lower container 12 from the containment cavity 38, the return lever rollers 104 roll along the sides of the lower container 12, and the container 12 holds the return lever 32 to a third position somewhat less than perpendicular to the housing 26. The spreader 24 lifts the container 12 past the vertical location of the return lever 32, and the return lever 32 finishes deployment by fully extending to a position perpendicular to the housing 26.

Next, during its re-deployment, the return lever 32 contacts a locating lever release 98. The locating lever release 98 is positioned such that its end is inserted next to two flanges 100 on either side of the locating lever 34. The locating lever release 98 is pulled downward when the return lever 32 fully deploys perpendicular to the housing 26. When the locating lever release 98 is pulled downward, an end of the locating lever release 98 inserted into the locating lever flanges 100 is removed from its position holding the flanges 100. Once the locating lever flanges 100 are released the locating lever 34 is able to deploy horizontal to the housing 26. The locating lever 34 returns to its initial position slightly below perpendicular to the housing 26. When the return lever 32 and the locating lever 34 are both fully deployed, the connector system 10 is prepared to receive a next cargo container.

The frame used with the method has attached thereto the locating lever 34, the return lever 32, the coupler plate 46, the locking pin 22, and at least one spring 56. During the first detecting step, the locating lever 34 detects the first container 12 as it is lowered into the containment cavity 38. The locating lever 34 contacts the outer surface of the first container 12 and is slightly depressed towards the frame 28 to a third, retracted position, as shown in FIGS. 4A and 4B, such that the locating lever 34 maintains contact with the first container 12 during a portion of the descent of the first container 12. As previously described, the locating lever 34 has a roller 36 on an end that permits contact with the first container 12 and/or spreader 24 to be maintained. In further steps of the method, the locating lever 34 determines when the first container 12 is presently being lowered into the containment cavity 38 of the rail car 16. The locating lever 34 may further track whether the spreader 24 remains in the containment cavity 38 or has been removed.

Further during the lowering of the first container 12, the return lever 32 snaps into a retracted position, tucked against the frame 28 once contacted by the first container 12 as depicted in FIGS. 6A and 6B. Following initiation of contact between the return lever 32 and the first container 12, the return lever 32 is retained in a position tucked against the frame 28 and housing 26 of the connector system 10 by a return spring locking mechanism 54. In this step, the return lever 32 is activated such that the at least one spring 56 is compressed in response to the first container 12 contacting the return lever 32. The retraction of the return lever 32 pushes the return spring locking mechanism 54 downwards compressing the return spring 56 and preparing the return mechanism for later steps.

In a next step, the spreader 24 is retracted, and the now unsupported coupler plate positioning arms 44 are released, in turn, releasing the coupler plate 46. The coupler plate 46, which begins in a tucked position inside or nearly inside the housing 26, as shown in FIG. 2, then falls forward to a horizontal position distal to the frame 28 and housing 26 during this step. The coupler plate 46 is deployed from a first, stowed position against the frame 28 to a second position extended substantially horizontally from the frame 28 in response to the locating lever 34 detecting that the first container 12 has been lowered into the containment cavity 38.

Referring again now to FIG. 8, an arrow illustrates the motion of the locking housing 48 as it is propelled to its deployed position. The second, extended position of the locking housing 48 may be seen in FIGS. 9A and 9B. In an embodiment, the locking housing 48 is released from its initial position by the locating lever 34. In such an embodiment, the locking housing 48 may extend to its deployed position, distal to the frame 28, in response to a step in which the spreader 24 passes by, and thus ceases to contact, the locating lever 34 as shown in FIG. 8.

Following completion of the above steps, once the first container 12 has been fully placed into the containment cavity 38 and the spreader 24 has been removed, both the return lever 32 and the locating lever 34 are in their retracted positions tucked against the frame 28. Additionally, at this point in the method, as depicted in FIGS. 9A and 9B, the previous series of steps have deployed the coupler plate 46 and the locking housing 48 to their second positions extending distal to the frame 28 beyond the housing 26.

In further steps, the second container 14 is lowered and contacts the locking pin 22, which retracts inside the locking housing 48. Retraction of the locking pin 22 permits the container 14 to contact the shelf flange 68 of the locking housing 48, shown in FIGS. 9A and 9B, as well as the coupler plate 46.

During these steps, as the second container 14 is lowered (see FIGS. 11A and 11B) the force exerted on the locking pin 22 causes the locking housing 48 and the entirety of the locking mechanism therein to move down along the frame 28 of the connector system 10. As the locking housing 48 is pushed downward the length of the frame 28, a locking housing return spring 78 is compressed by an interior portion of the locking housing 48, as seen in FIG. 11C, until the locking housing 48 meets the coupler plate 46. At this point, the second container 14 also meets the coupler plate.

When the second container 14 meets the coupler plate 46 and the first container 12, a connection step is performed. During the connection step, the coupler plate 46, along with its connecting pins 20a, 20b, and the locking housing 48, along with the locking pin 22, together connect the first container 12 to the second container 14. The connection takes place in part because the second container 12 is lowered on top of the first container 14 such that the coupler plate is positioned between the first container 12 and the second container 14. Further the connection takes place because the coupler plate 46 has thereon a plurality of connecting pins 20a, 20b that are inserted into the first and second containers 12, 14 when the second container 14 is lowered onto the first container 12, and the locking pin 22 is deployed such that it is inserted into one of the first and second containers 12, 14.

Once securely connected, the second container 14 rests on top of the first container 12 with the coupler plate 46 therebetween, and the upper and lower connecting pins 20a, 20b, along with the locking pin 22, prevent horizontal motion of the containers 12, 14. In a next step, the second container 14 is removed by the spreader 24 and the containers 12, 14 are decoupled. During this step, as the second container 14 is lifted out of the rail car 16 by the spreader 24, the lower connecting pin 20b is extracted from the vertical connecting point 70 of the first container 12. The second container 14 remains attached to the coupler plate 46 and locking housing 48 by way of the combination of the upper connecting pin 20a and the locking pin 22. Thus, the upward force of the casting on the locking pin 22 causes the locking pin 22, locking housing 48, and the coupler plate 46 attached to the locking pin 22 to move upwards. Likewise, the frame 28 of the connector system 10 rises along the track provided within the housing 26. The rise of the entirety of the frame 28 and the components carried thereon may be aided by the retraction of the counter balance pulley 30 or other components of the return mechanism. As this step progresses, the counter balance pulley reservoir 92 retracts any length of pulley extracted during the descent of the frame 28.

As removal of the second container 14 continues, the locking housing 48 and locking pin 22 are returning to their initial position and the coupler plate 46 is likewise retracted by the return mechanism and returned to its initial position tucked against the frame 28. The return lever 32 controls the release of the coupler plate positioning arms 44. Upon the release of the coupler plate positioning arms 44 and the return of the coupler plate 46, the return lever 32 is re-deployed to a third position contacting the first container 12 with the roller 104 carried thereon. The third position of the return lever 32 is in-between fully extended and tucked against the frame 28 because the first container 12 stops the full extension of the return lever 32. The return lever 32 maintains the contact through the removal step for the first container 12.

Following the removal step for the second container 14, a removal step for the first container 12 commences. As the spreader 24 begins lifting the first container 12 from the containment cavity 38, the return lever roller(s) 104 passes along the side of the container 12 maintaining contact as described above. During this step, the spreader 24 lifts the container 12 past the elevation of the return lever 32 and the return lever 32 finishes deployment by fully extending to a position perpendicular to the housing 26. In response to the full extension of the return lever 32, the locating lever 34 is released from the tucked position. The retraction of the locating lever 34 until after the first container 12 is removed prevents the locating lever flanges 40 from interfering with the return action of the coupler plate positioning arms 44. The locating lever 34 returns to its initial position slightly below perpendicular to the housing 26. When the return lever 32 and the locating lever 34 are both fully deployed, the method of connecting containers with the connector system 10 may begin again.

### INDUSTRIAL APPLICABILITY

Currently containers stacked one on top of another are secured to each other through the use of a connector that has to be manually inserted and locked or unlocked each time a rail car is loaded or unloaded. Manually connecting containers may be dangerous, time consuming, and slow.

In contrast, the connector system for securing stacked containers described herein may be used to lock stacked containers together without the need for manual intervention thus increasing efficiency. Further, the connector system and method described may be more reliable than manual insertion of connection means. Finally, the system may be applied in many circumstances that require or might benefit from automated connection of stack containers. The connector system and method may be used on rail cars as well as truck chassis, buffers, ships, and storage spaces. The connector system and method when used across these platforms increases efficiency, speed, and safety further still. The connector system may be arranged along the side of the rail car and containers, thereby providing easy manual access to the system before, during, and following connection of the containers.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

We claim:

1. A connector system for connecting stacked containers comprising:
a frame;
a locating lever coupled to the frame, the locating lever configured to detect when a lower container is placed into a containment cavity;
a coupler plate, the coupler plate tucked along the frame in a starting position,
wherein the coupler plate is deployed distal to the frame to a deployed position in response to the locating lever detecting when the lower container is placed into the containment cavity;
a plurality of connecting pins, the coupler plate and the connecting pins configured to connect an upper container to the lower container;
a return lever coupled to the frame; and
a return mechanism whereby the coupler plate is returned to the starting position in response to the upper container being lifted off of the lower container.

2. The connector system of claim 1, wherein at least one of the plurality of connecting pins is attached to the coupler plate; and
wherein the at least one of the plurality of connecting pins connects to at least one casting on the upper container and the lower container.

3. The connector system of claim 2, further comprising:
a locking housing, the locking housing tucked against the frame in a starting position,
wherein the locking housing is deployed distal to the frame to a deployed position in response to the locating lever detecting when the lower container is placed into the containment cavity;
wherein at least one of the plurality of connecting pins is a locking pin; and
wherein the locking pin is housed within the locking housing.

4. The connector system of claim 3, wherein the coupler plate, when in the deployed position, is between the lower container and the upper container such that the plurality of connecting pins thereon are inserted into the lower container and the upper container.

5. The connector system of claim 4, wherein the locking housing, when in the deployed position, aligns the locking pin with the upper container such that the locking pin is inserted into the casting of the upper container.

6. The connector system of claim 5, further comprising a locking pin spring that pushes the locking pin out of the locking housing and into the casting of the upper container.

7. The connector system of claim 3, wherein the locating lever extends distal to the frame in a starting position such that the locating lever contacts the lower container when the lower container is placed into the containment cavity; and
wherein the return lever extends distal to the frame in a starting position such that the return lever contacts the lower container when the lower container is placed into the containment cavity.

8. The connector system of claim 7, wherein the locating lever is tucked against the frame in a retracted position;
wherein the return lever is tucked against the frame in a retracted position;
wherein the locating lever moves from the starting position of the locating lever to the retracted position of the locating lever in response to the lower container being placed in the containment cavity; and
wherein the return lever moves from the starting position of the return lever to the retracted position of the return lever in response to the lower container being placed in the containment cavity.

9. The connector system of claim 8, wherein the return mechanism includes at least one spring and the at least one spring is compressed by the return lever as the return lever moves from the starting position of the return lever to the retracted position of the return lever in response to the lower container being placed in the containment cavity; and
wherein the spring is released in response to the upper container being lifted off of the lower container, such that the release of the spring returns the coupler plate to the starting position of the coupler plate and the release of the spring returns the return lever to the starting position of the return lever.

10. The connector system of claim 8, wherein the locating lever contacts the lower container in a third position when the locating lever is between the starting position of the locating lever and the retracted position of the locating lever, the third position varying within a first range; and
wherein the locating lever maintains contact with the lower container, the lower container varying in width from 96 inches to 102 inches, as the lower container is placed in the containment cavity.

11. The connector system of claim 10, wherein the return lever contacts the lower container in a third position when the locating lever is between the starting position of the return lever and the retracted position of the return lever, the third position varying within a second range; and
wherein the return lever maintains contact with the lower container, the lower container varying in width from 96 inches to 102 inches, as the lower container is removed from the containment cavity.

12. The connector system of claim 1, further comprising:
a housing along the side of the containment cavity;
wherein the frame moves vertically within the housing; and
wherein the frame moves downward from a first position to a second position in response to the upper container contacting the coupler plate when the upper container is placed on top of the lower container.

13. The connector system of claim 12, further comprising:
a pulley mechanism, wherein the pulley mechanism is configured to assist in vertical movement of the frame; and
wherein the pulley mechanism returns the frame to the first position from the second position when the upper container is disconnected from the lower container.

14. The connector system of claim 13, wherein the containment cavity is one of a rail car, a chassis, and a buffer.

15. A connector system for securing containers for transport or storage, comprising:
a frame, the frame including a plurality of levers and a plurality of springs, the levers and springs configured such that the levers are contacted by a lower container when the lower container is placed into a containment cavity;
a plurality of connecting pins;
a coupler plate, at least one of the plurality of connecting pins attached to the coupler plate;
wherein the coupler plate is arranged alongside the frame in a stored position until one of the plurality of levers is contacted by the lower container; and
wherein the coupler plate is deployed in response to one of the plurality of levers being contacted by the lower container, the coupler plate when deployed extending substantially horizontal from the frame to a deployed position.

16. The connector system of claim 15, further comprising:
a locking housing, the locking housing tucked against the frame in a stored position,
wherein the locking housing is deployed distal to the frame to a deployed position in response to at least one of the plurality of levers;
wherein at least one of the plurality of connecting pins is a locking pin; and
wherein the locking pin is housed within the locking housing.

17. The connector system of claim 16, the plurality of levers comprising:
a locating lever, wherein the locating lever extends distal to the frame in a starting position such that the locating lever contacts the lower container when the lower container is placed into the containment cavity; and
a return lever, wherein the return lever extends distal to the frame in a starting position such that the return lever contacts the lower container when the lower container is placed into the containment cavity.

18. The connector system of claim 17, wherein the locating lever is tucked against the frame in a retracted position;
wherein the return lever is tucked against the frame in a retracted position;
wherein the locating lever moves from the starting position of the locating lever to the retracted position of the locating lever in response to the lower container being placed in the containment cavity; and
wherein the return lever moves from the starting position of the return lever to the retracted position of the return lever in response to the lower container being placed in the containment cavity.

19. The connector system of claim 18, wherein the coupler plate, when in the deployed position, inserts the plurality of connecting pins into an upper container and the lower container in response to the upper container being stacked on the lower container within the containment cavity.

20. The connector system of claim 19, wherein at least one spring of the plurality of springs is compressed by the return lever as the return lever moves from the starting position of the return lever to the retracted position of the return lever in response to the lower container being placed in the containment cavity; and
wherein the at least one spring is released in response to the upper container being lifted off of the lower container, such that the release of the at least one spring returns the coupler plate to the stored position of the coupler plate and the release of the at least one spring returns the return lever to the starting position of the return lever.

21. A method for securing containers, comprising:
lowering a first container into a containment cavity, the containment cavity having a frame aligned therealong, the frame having attached thereto a locating lever, a return lever, a coupler plate, a locking pin, and at least one spring;
detecting the first container with the locating lever as the first container is lowered into the containment cavity;
activating the return lever such that the at least one spring is compressed in response to the first container contacting the return lever;
deploying the coupler plate from being stowed against the frame in a first position to extended substantially horizontally from the frame in a second position in response to the locating lever detecting that the first container has been lowered into the containment cavity;
lowering a second container on top of the first container such that the coupler plate is positioned between the first container and the second container; the coupler plate having thereon a plurality of connecting pins that are inserted into the first and second containers when the second container is lowered onto the first container; and
deploying the locking pin, the locking pin being inserted into one of the first and second containers when it is deployed.

22. The method of claim 21, wherein the frame has a locking housing tucked against the frame in a first position;
the method further comprising:
deploying the locking housing distal to the frame to a deployed position in response to the locating lever, and wherein the locking pin is partially within the locking housing;
connecting the first and second container with the connecting pins; and
securing the first and second container in the containment cavity with the coupler plate and locking housing.

23. The method of claim 22:
wherein the locating lever moves from extended out from the frame in a first position of the locating lever to tucked against the frame in a second position of the locating lever in response to the detecting that the first container has been lowered into the containment cavity; and
wherein the return lever moves from extended out from the frame in a first position of the return lever to tucked against the frame in a second position of the return lever in response to the activating of the return lever.

24. The method of claim 23, further comprising:
releasing the at least one spring in response to the first container being lifted off of the second container, such that the release of at least one spring returns the coupler plate to the first position of the coupler plate and the release of the at least one spring returns the return lever to the first position of the return lever.

25. The method of claim 24, wherein the return lever and the locating lever are extended out in their respective first positions when the coupler plate is stowed against the frame in the first position of the coupler plate, and wherein the coupler plate is deployed to the second position of the coupler plate when the return lever and the locating lever are stowed in their respective second positions.

26. The method of claim 25, wherein more than one frame is aligned on the side of the containment cavity, the method further comprising:
performing the steps of the method with the more than one frame; and
performing the steps of the method on one or more sides of the containment cavity.

27. The method of claim 25, wherein the containment cavity is one of a rail car, a chassis, and a buffer.
